(19) United States
(12) Patent Application Publication
(10) Pub. No.: US 2026/0317077 A1
(43) Pub. Date: Oct. 15, 2026

(54) AIRLESS ACCUMULATION CONVEYING SYSTEM

(71) Applicant: Dematic Corp., Grand Rapids, MI (US)

(72) Inventors: Harry T. German, Belding, MI (US); Spencer G. Knizacky, Grand Rapids, MI (US); Tyler D. Ernest, Cedar Springs, MI (US)

(21) Appl. No.: 19/645,654

(22) Filed: Apr. 13, 2026

Related U.S. Application Data
(60) Provisional application No. 63/787,486, filed on Apr. 11, 2025.
(60) Provisional application No. 63/820,958, filed on Jun. 10, 2025.

(51) Int. Cl. B65G 47/26

(52) U.S. Cl. CPC B65G 47/261

(57) ABSTRACT

An airless accumulation conveying system suitable for a site such as warehouse, fulfillment, e-commerce, manufacturing setting, and the like, includes a plurality of conveyor rollers that define a conveying surface and a plurality of sensors for detecting and/or identifying articles transported on the conveying surface. The rollers include one or more drive rollers, support rollers, and idle rollers. The drive rollers include a housing and bearing assemblies at ends of the housing, and an electro-mechanical clutch between the housing and one of the bearing assemblies. When the clutch is energized, the clutch transmits torque to drive rotation of the drive roller housing, and when the clutch is not energized, the drive roller housing is freely rotatable.

### CROSS REFERENCE TO RELATED APPLICATION

The present application claims the priority benefits of U.S. provisional patent applications Ser. No. 63/787,486, filed on Apr. 11, 2025, and Ser. No. 63/820,958, filed on Jun. 10, 2025, both of which are incorporated herein by reference in their entireties.

### TECHNICAL FIELD

The disclosure relates generally to a conveyor system, and in particular to an airless accumulation conveying system.

### BACKGROUND

Unless otherwise indicated herein, the materials described in this section are not prior art to the claims in this application and are not admitted to the prior art by inclusion in this section.

Current accumulation conveyors may utilize pneumatic actuation. While pneumatic actuation is effective, it (a) is cumbersome, (b) requires additional expenses for installation, and (c) is costly for maintaining and operating a compressor. Other conventional accumulation conveyors run on all electric and thus do not require a compressor system to supply pneumatic energy. Such conventional accumulation conveyors use an electromagnetic actuator that is expensive to install and maintain.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In accordance with aspects of the present disclosure, an airless accumulation conveying system suitable for a site such as a warehouse, fulfillment, e-commerce, manufacturing, and the like, includes a plurality of conveyor rollers defining a conveying surface, and a plurality of sensors for detecting and/or identifying articles transported on the conveying surface, with the rollers including one or more of drive rollers, support rollers, and idle rollers.

In a particular embodiment the airless accumulation conveying system further includes a continuous belt to selectively drive at least a portion of the conveying surface.

In any embodiment the conveying system includes a pair of side channels between which the conveyer rollers are disposed.

In any embodiment the sensors may be configured as one or more of pairs of photoeyes and reflectors, optical sensors, infrared (IR) sensors, object sensors, cameras, imaging sensors, Lidar sensors, radar sensors, sonar sensors, or other suitable sensing device, micromechanical system (MEMS) sensors, nano sensors, electrodes. The sensors may be mounted to the side channels.

In a particular embodiment, the conveyor rollers include a plurality of drive rollers and a plurality of idle rollers each drivingly coupled to another roller through a plurality of transmission belts, such as O-rings for example.

In particular embodiments, each drive roller includes a housing, a first bearing assembly at one end of the housing, a second bearing at an opposed end of the housing, and an electro-mechanical clutch, such as a wrapped-spring clutch, between the housing and one of the bearing assemblies. When the clutch is energized, the clutch transmits torque to drive rotation of the drive roller housing, and when the clutch is not energized, the drive roller housing is freely rotatable with respect to the first and second bearing assemblies and the clutch.

In particular embodiments, the conveying system may further include a pressure support and a bracket for mounting the pressure support to the side channel, where the drive roller is also mounted to the side channel above or below the pressure support. The pressure support may be used to aid in engagement of a belt with one or more conveyor rollers, such as the drive rollers.

In any of the embodiments, the conveying system may further comprise a control system in electronic communication with various other components of the conveying system, such as where the control system carries out the control of drive rollers in such a manner as to deliver articles to an appropriate load transfer point.

In accordance with another aspect of the present disclosure, an airless accumulation conveying system includes a plurality of conveyor rollers comprising a drive roller and a group of idle rollers, with the at least the group of idle rollers forming a conveying surface and being drivingly coupled together, and with the drive roller being drivingly coupled to an idle roller, and the drive roller being configured to be selectively switched between an idle mode and a drive mode to selectively drive the idle rollers. A continuous drive belt is supported below the group of idle rollers and is configured to transmit torque to the drive roller so that when the drive roller is in the drive mode, the drive roller is operable to drive the idle rollers.

In any of the embodiments, the drive roller may include a housing and a wrap spring clutch, wherein when the wrap spring clutch is energized, a wrap spring transmits torque to allow the drive belt to drive rotation of the drive roller housing, and when the wrapped-spring clutch is not energized, the drive roller housing is drivingly disengaged from the drive belt and is freely rotatable and operates in an idle mode.

In particular embodiments the conveying system the drive roller includes bearing assemblies at either of opposed ends of the housing and the wrapped-spring clutch is disposed between the housing and one of the bearing assemblies.

In particular embodiments, the drive roller may form a part of the conveying surface.

In other particular embodiments, the drive roller may be located below the idler rollers and not form part of the conveying surface.

In accordance with still another aspect of the present disclosure, a drive roller for a conveying system comprises a cylindrical housing having a longitudinal axis of rotation, a first bearing assembly at a first end of the cylindrical housing for mounting one end of the drive roller in a conveyor section of a conveying system, a second bearing at an opposed end of the cylindrical housing for mounting a second, opposed end of the drive roller in a conveyor section of a conveying system, and an electro mechanical clutch between the housing and the second bearing assembly, wherein when the clutch is energized, the clutch is operable to transmit torque to drive rotation of the drive roller housing about the longitudinal axis of rotation, and wherein when the clutch is not energized, the drive roller housing is freely rotatable with respect to the first and second bearing assemblies and the clutch.

In any of the embodiments the clutch is configured as a wrapped-spring clutch.

Also in any of the embodiments, the clutch may include an outer housing forming an engagement surface for engagement by a drive belt.

Also in any of the embodiments, the wrapped-spring clutch further includes an insert extending from the outer housing to form a press fit coupling with the cylindrical housing of the drive roller.

The airless accumulation system of the present disclosure enables precise and accurate control of conveyor systems, including segments of conveyor systems, without using air actuated controls, such as to accumulate goods at sections and/or deliver such goods to transfer points. The system reduces the number of components and/or complexity compared to other such accumulation conveyors. These and other advantages will become apparent upon review of the accompanying drawings and detailed descriptions of the embodiments.

### BRIEF DESCRIPTION OF THE DRAWINGS

FIG. 1 is a top plan view of an airless accumulation conveying system, in accordance with one or more embodiments of the disclosure;

FIG. 2 is a sectional view taken along the lines A-A in FIG. 1, in accordance with one or more embodiments of the disclosure;

FIG. 3 is a partial perspective view of a section of the conveying system with two of the conveyor rollers shown in an exploded view, in accordance with one or more embodiments of the disclosure;

FIG. 4A is a first end perspective view of a driver conveyor roller in accordance with one or more embodiments of the disclosure;

FIG. 4B is an opposite end perspective view of the driver conveyor roller of FIG. 4A;

FIG. 4C is an exploded perspective view of the driver conveyor roller of FIG. 4A;

FIG. 5 is a partial exploded view of a portion of the conveyor roller of FIG. 4A;

FIG. 6A is a sectional view taken along the lines B-B in FIG. 5;

FIG. 6B is another cross-section view of the driver conveyor roller of FIG. 4A;

FIG. 6C is an enlarged end portion of the drive roller of FIG. 6B illustrating a clutch assembly;

FIG. 6D is an enlarged opposed end portion of the drive roller of FIG. 6B illustrating the bearing assembly;

FIG. 7 is an enlarged end portion of the drive roller, in accordance with one or more embodiments of the disclosure, illustrating the pressure support that supports the drive belt to drive the drive roller;

FIG. 8 is a partial perspective view of a conveying system with an example controller system in electronic communication with various other components of an example airless accumulation conveying system, in accordance with one or more embodiments of the disclosure;

FIG. 9 is a partial top side perspective view of another embodiment of a conveying system, in accordance with one or more embodiments of the disclosure, where the drive rollers are beneath the conveying surface of the conveying section;

FIG. 10 is a bottom side perspective view of the conveying system of FIG. 9; and

FIG. 11 is an enlarged view of detail XI of FIG. 10.

### DETAILED DESCRIPTION

For the purposes of promoting an understanding of the principles of the disclosure, reference will now be made to the embodiments illustrated in the drawings and described in the following written specification, wherein like reference numerals represent like parts and assemblies throughout the several views. It is understood that no limitation to the scope of the disclosure is thereby intended. It is further understood that the disclosure includes any alternatives and modifications to the illustrated embodiments and includes further applications of the principles of the disclosure as would normally occur to a person of ordinary skill in the art to which this disclosure pertains.

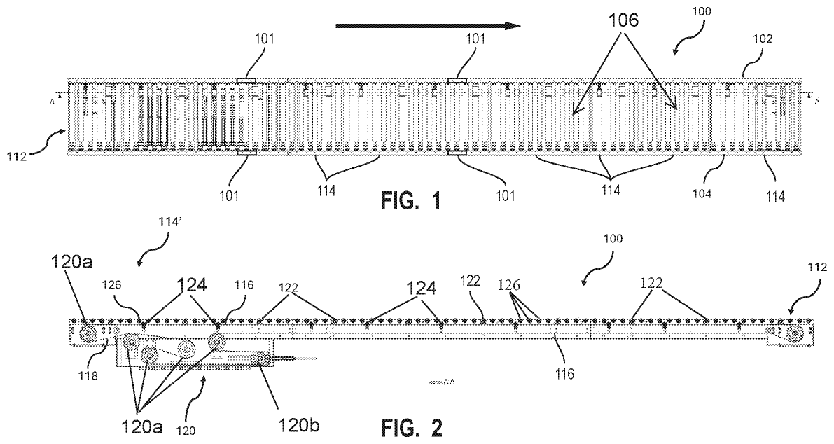

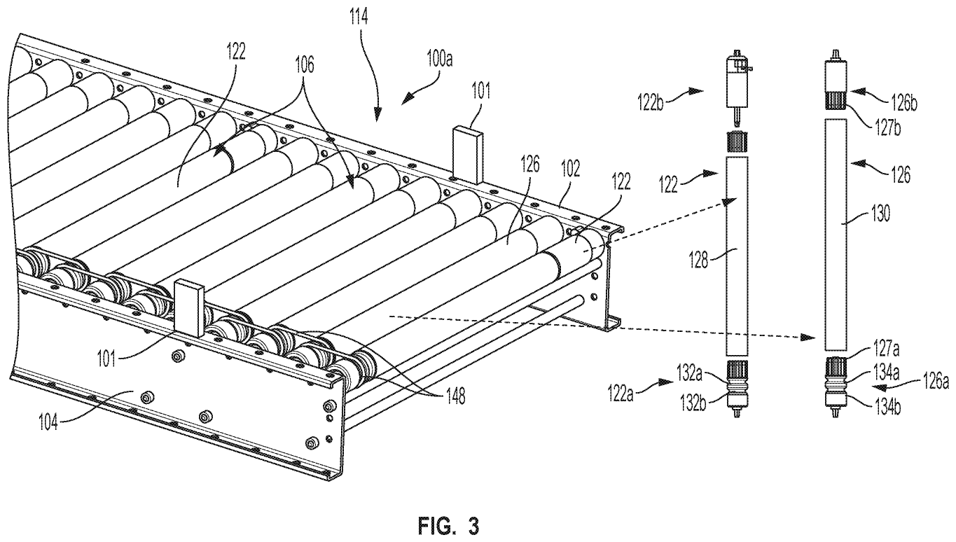

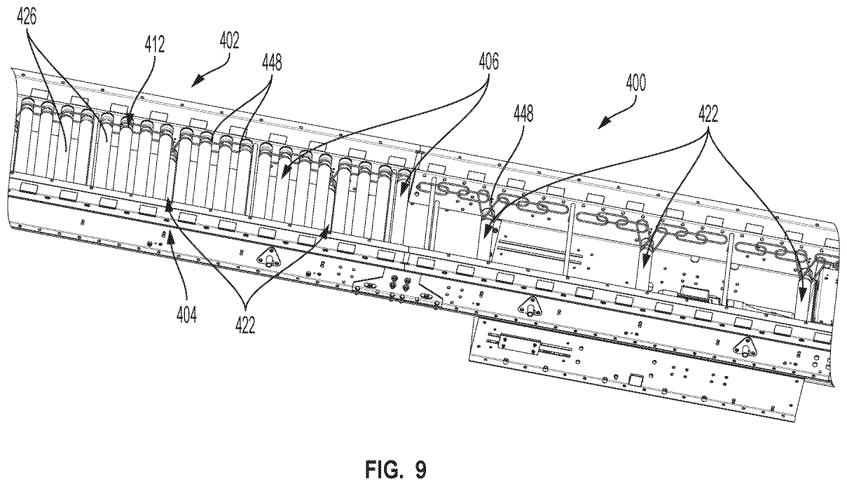

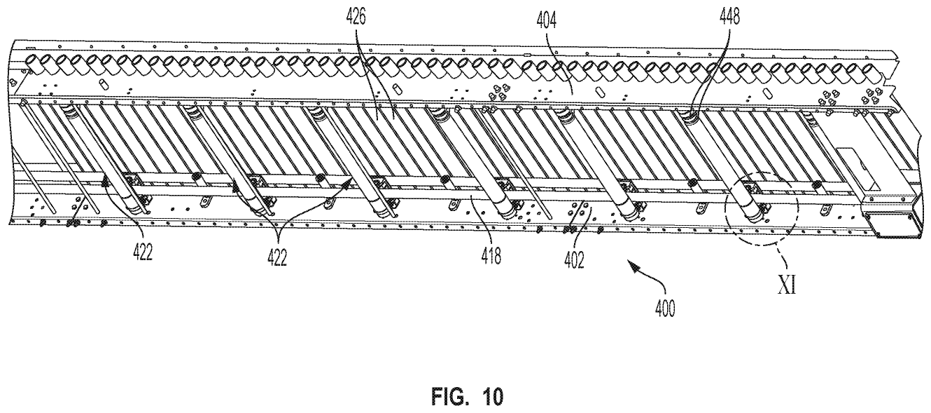

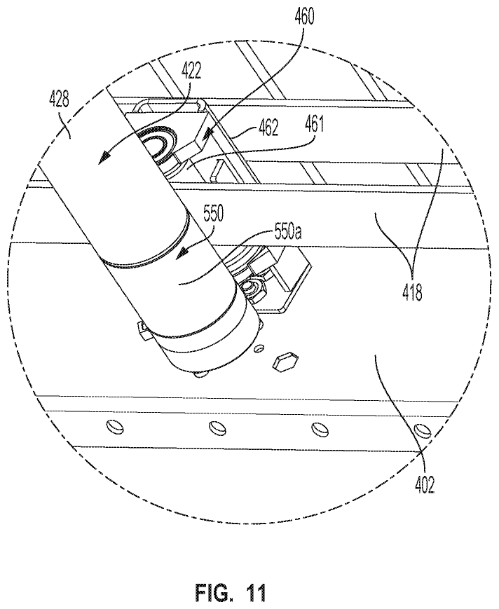

FIG. 1 illustrates a top plan view of an airless accumulation conveying system 100 suitable for a site such as warehouse, fulfillment, e-commerce, manufacturing, and so forth in accordance with one or more implementations. The airless accumulation conveying system 100 includes a plurality of zones 114 which are either individually or group controllable. Each zone of airless accumulation conveying system 100 includes a plurality of conveyor rollers 106 defining a conveying surface 112 for conveying articles (not shown) in a direction of conveyance indicated by an arrow from left to right, which may be selectively driven such as by a chain or a conveying belt (not shown). The articles may have different sizes, shapes, weights, and dimensions and may include trays, boxes, cases, pallets, bins, products, envelopes, packages and the like. Each of the conveyor rollers 106 is rotatably mounted to and extended between opposite sidewalls 102, 104. In some implementation, the conveying surface 112 may include one or more continuous belts 116 and/or O-rings 148 (e.g., FIG. 3) routed or reeved around the drive rollers 122 and idle rollers 126 to transmit rotation from the drive rollers to the idle rollers. Further, in some embodiments, the drive rollers may form part of the conveying surface 112 (e.g., FIGS. 1-3) or be mounted below the conveying surface, such as shown in FIGS. 9 and 10, to drive the idle rollers via transmission belts in the form of O-rings 148 or belts 116. Not all of the depicted systems may be used in all implementations, however, and one or more implementations may include additional or different components that those depicted in the figure. Variations in the arrangement and type of the components may be made without departing from the spirit or scope of the claims as set forth herein. Additional components, different components, or fewer components may be provided.

The airless accumulation conveying system 100 further includes an array of sensors 101 supported by or mounted on the sidewalls 102, 104 using any suitable method of attachments to detect or identify the articles transport on the conveying surface 112. Alternatively, the sensors facing the conveying surface 112 may be supported by or mounted on a fixture to either form a portion of the airless accumulation conveying system 100 or be independent from the airless accumulation conveying system 100. The sensors 101 may include pairs of photoeyes and reflectors, optical sensors, infrared (IR) sensors, object sensors, cameras, imaging sensors, Lidar sensors, radar sensors, sonar sensors, or other suitable sensing devices. In some implementations, the sensors may be micromechanical system (MEMS) sensors, nano sensors, electrode, or the like encapsulated within or integrated into the sidewalls 102, 104, conveyor rollers 106, belts 116, O-rings 148, above the conveying surface 112, a fixture directly/indirectly forms as a portion of the conveying system 110, or combinations therefore defining a sensing system for detecting, identifying, classifying, or monitoring the articles. In another embodiment, sensor may be used to monitor the activity and/or conditions below the conveying surface 112. Alternatively, the sensing system may also serve other functions to control the conveyor rollers 106, the chain or belt such as start, stop, pause, deaccelerate, accelerate, and combination thereof.

FIG. 2 illustrates a sectional view of an airless accumulation conveying system 100 taken along the line A-A in FIG. 1 in accordance with one or more implementations. The conveyor rollers 106 include one or more of motorized or drive rollers 122, support rollers 124, and idle rollers 126. In the illustrated embodiment, the drive rollers 122 and idle rollers 126 form part of the conveying surface 112.

Airless accumulation conveying system 100 further includes a continuous belt 116. Continuous belt 116 may form part of the conveying surface and extend along a portion or entire length of the respective zone and may be is stretched between a drive roller 122 and a tensioning roller (not shown) at opposite ends of the zone (zone 114′ is illustrated). Alternately, as illustrated, continuous belt 116 may be configured to drive one or more drive rollers 122 in zone 114′ and be located below the conveying surface 112, as described below. Further, when the drive roller(s) 122 is or are located beneath the conveying surface, the continuous belt 116 may be similarly located below the conveying surface 112 and drive the drive rollers 122 with its lower loop (as shown and discussed in reference to FIG. 10).

In one embodiment, the drive roller 122 in the zone may be a leading roller.

In another embodiment, the driver roller 122 may be a trailing roller in the zone.

In the illustrated embodiment, continuous belt 116 is located below the conveying surface 112 and is supported by support rollers 124, which are freely rotatable rollers mounted between side channels 102, 104, and support the conveying belt 116 in an interior of the zone 114′ (FIG. 2). In the illustrated embodiment, conveying belt 116 is a continuous closed loop drive belt 118 that is driven by an electric drive assembly 120 located beneath the conveying surface 112. Drive assembly 120 includes a plurality of pulleys 120a, including an adjustable pulley 120b (which allows the tension on belt 118 to be adjusted), about which belt 118 is looped so that drive belt 118 is continuously rotated by the electric drive assembly 120.

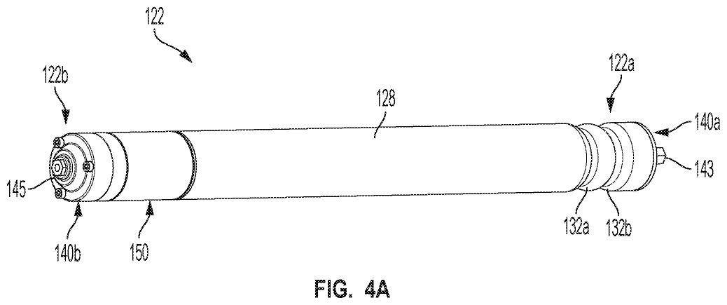

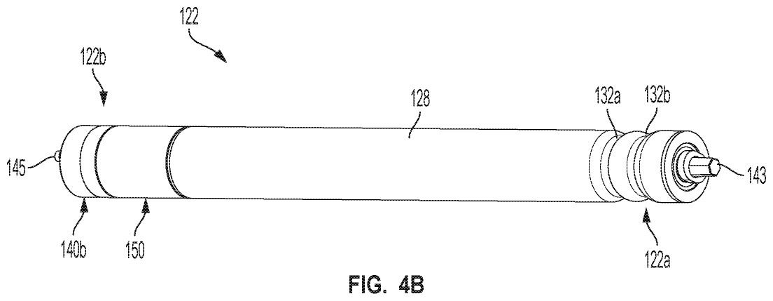

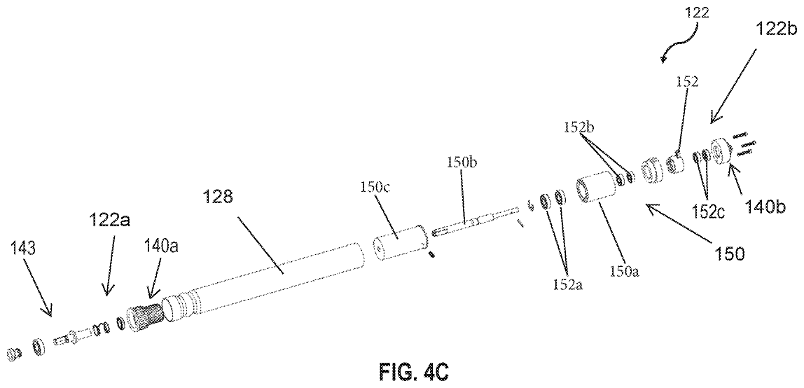

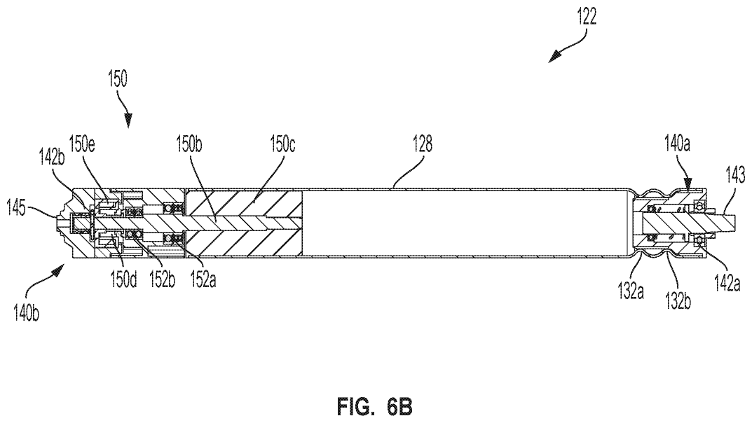

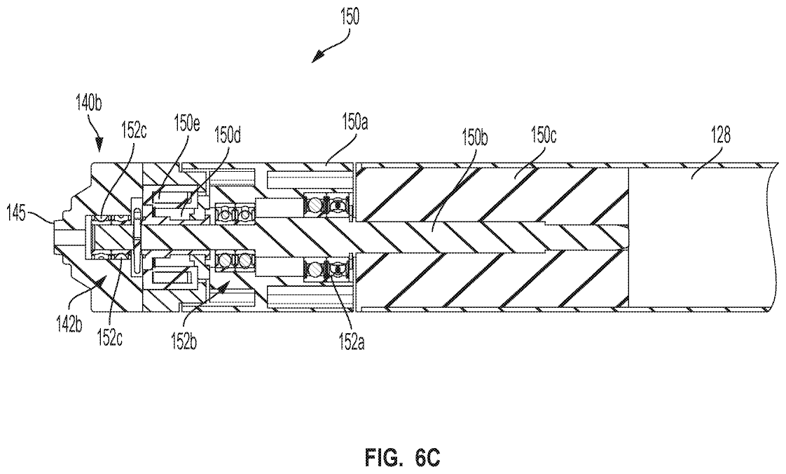

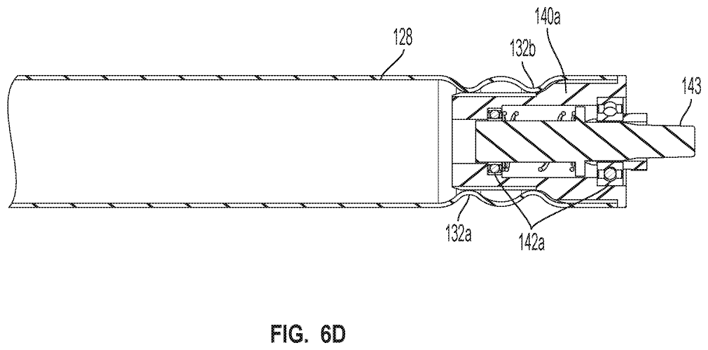

Referring to FIG. 3, in one embodiment, as noted, conveyor rollers 106 include a plurality of drive rollers 122 and idle rollers 126 that form conveying surface 112. Conveyor rollers 106 are mounted between and to side channels 102, 104 mechanically, operatively, or any suitable forms of coupling, so that they can rotate to covey packages supported thereon. In the illustrated example, the drive rollers 122 and the idle rollers 126 are coupled to each other through a plurality of transmission belts in the form of O-rings 148 to transmit torque between the rollers. As depicted, each of the drive rollers 122 and the idle rollers 126 includes a first end 122a, 126a and a second end 122b, 126b. At least one groove, and optionally two grooves 132a, 132b, 134a, 134b are pre-formed on first ends 122a, 126a, of the respective rollers to receive O-rings 148. In FIG. 3 rollers 122, 126 are depicted with sections containing grooves 132a, 132b, 134a, 134b apart from housings 128, 130. It should be appreciated, however, that housings 128, 130 may be formed to include 132a, 132b, 134a, 134b, such as shown in FIGS. 4A-4C, 6B and 6D.

Referring to FIGS. 4A-4C, each drive roller 122 includes a cylindrical housing 128 with a first bearing assembly 140a with annular bearings 142a (FIG. 6D) inserted into first end 122a of drive roller 122, which mounts first end 122a into the side channel 104 via a first hex axle 143, and a second bearing assembly 140b at second end 122b of drive roller 122, which mounts second end of driven roller 122 via a second hex axle 145 (FIG. 4A) into the opposed side channel 102.

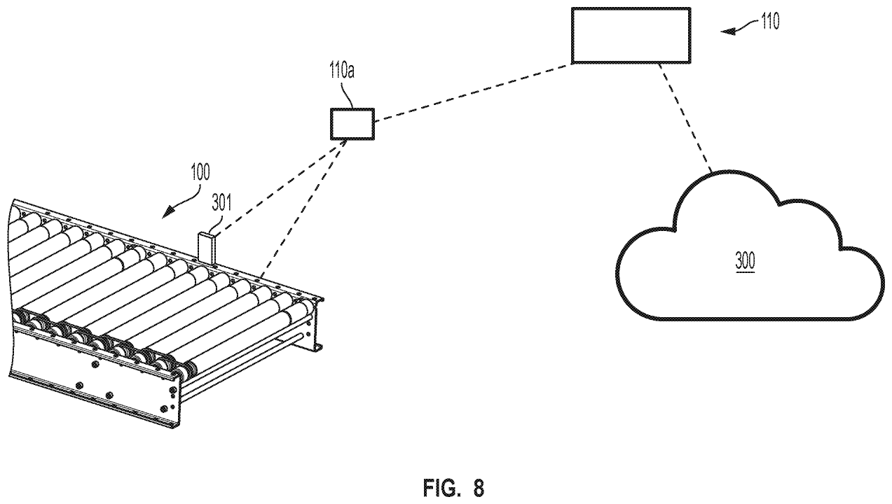

Located at second end 122b of driver roller 122, between second bearing assembly 140b and cylindrical housing 128, is a clutch 150, which, as will be more fully described, is selectively energized by the control system 110, for example a zone controller 110a of the control system 110 (FIG. 8) either wirelessly or wired, to change its state from a driving state (where it drives the roller's housing 128 of drive roller 128) to a non-driving state where it no longer drivingly rotates the roller's housing 128 about the hex axles so that the clutch 150 can selectively transform the roller from an idle roller to a drive roller.

Referring again to FIG. 3, idle roller 126 also includes a cylindrical housing 130 with ends 126a, 126b for mounting the idle roller 126 to side channels 102, 104 by conventional methods of attachments, such as hex axles, so that the cylindrical housing 130 can rotate about the hex axles. For example, each of ends 126a, 126b may include bearing assemblies 127a, 127b that respectively mount with or to cylindrical housings 130 to enable housing 130 to rotate about or relative to ends 126a, 126b.

Referring to FIG. 56C, as noted above, clutch 150 may comprise a wrapped-spring clutch. Clutch 150 includes an outer housing 150a, which forms an engagement surface for engagement by a drive belt, and a shaft 150b with an insert 150c mounted on one end thereof that extends into the cylindrical housing 128 of drive roller 122. Insert 150c is sized to form a press fit coupling with housing 128 so that as shaft 150b is rotated, the insert 150c will rotate the cylindrical housing 128. The opposed end of shaft 150b extends into bearing assembly 140b and is supported therein by annular bearings 142b so that the clutch can freely rotate with respect the bearing assembly 140b. Outer housing 150a also houses annular bearings 152a, 152b that support the outer housing 150a about shaft 150b and an internal wrap spring 150d that wraps around shaft 150b. Although a pair of bearings 152a, 152b are illustrated, a single bearing 152a, 152b being housed on the front and back of the outer housing 150a are sufficient. In addition, outer housing 150a includes an internal stationary coil 150e that is in electrical communication with an input connection 152 for powering the internal stationary coil via the control system 110, such as the zone controller 110a. The clutch 150 further includes a third pair of bearings 152c for supporting the second bearing assembly 140a. Similar to bearings 152a, 152b, a single bearing is sufficient to support the second bearing assembly 140a. Without departing from the spirit of the application, more than one bearing 152a, 152b, 152c may be employed.

In the illustrated embodiment, outer housing 150a is driven by the upper run of drive belt 118 (which runs beneath the drive roller 122 and supported by support rollers 124) and is in constant motion (rotation) about shaft 150b when the internal wrap spring is in its unactuated state. However, because the wrap spring is not activated, the rotation of outer housing 150a is not transmitted to cylindrical housing 128 so that drive roller 122 operates in an idle mode.

In contrast, when a current is applied to the wrapped-spring clutch 150, the internal stationary coil 150e generates lines of magnetic flux that cause the internal wrap spring 150d to active and, hence, engage and transmit a torque to the internal shaft 150b. As the shaft 150b rotates due to motion of the outer housing 150a, the insert 150c then transmits the torque to the housing 128 thus in effect transforming the drive roller 122 from an idle roller to a drive roller as driven by the drive belt. When the wrapped-spring clutch 150 is no longer actuated, the internal wrap spring 150d disengages from the shaft 150b, and the cylindrical housing 128 of drive roller 122 is once again freely rotatable with respect to the wrapped-spring clutch 150 and no longer driven by the drive belt 118, and hence returned to an idle mode.

As noted above, clutch 150 includes an input connector 152 for coupling to an electrical cable or wire (not shown) that is in communication with and controlled by the control system 110 noted above. In one embodiment, the input connector 152 is extending from the outer housing 150 to form a press fit coupling with the outer housing 150a. In another embodiment, the input connector 152 includes a center bearing with bushing may be incorporated inside the outer housing 150a. Depending on the application, such center bearing with bushing may not be required. In an alternative embodiment, the connection may be in electrical communication with an energy storage system, such as, but not limited to supercapacitors or ultracapacitors, for powering the drive roller 122, which is then in turn in electrical communication with the control system 110, such as the zone controller 110a. In yet another embodiment, the connection may be coupled to a power source, which is in turn includes a wireless connection for communicating with an off-board controller, PLC, warehouse system such as a warehouse-controlled system (WCS), or combination thereof.

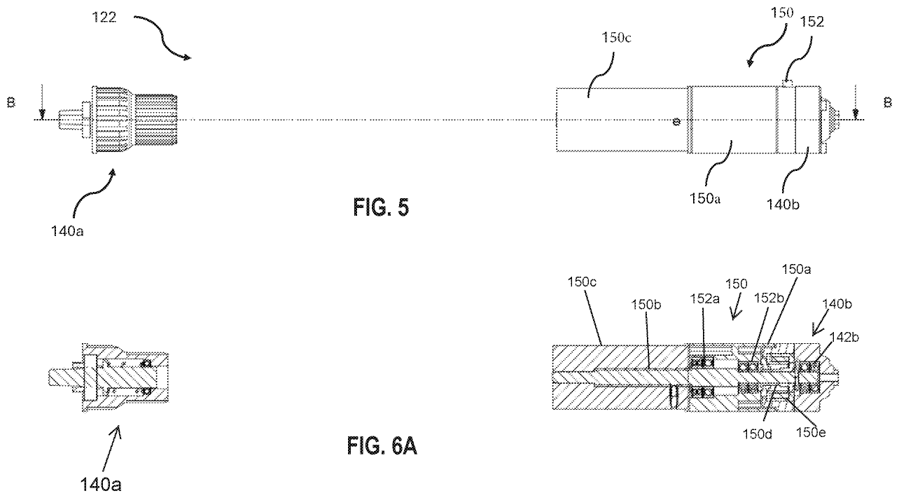

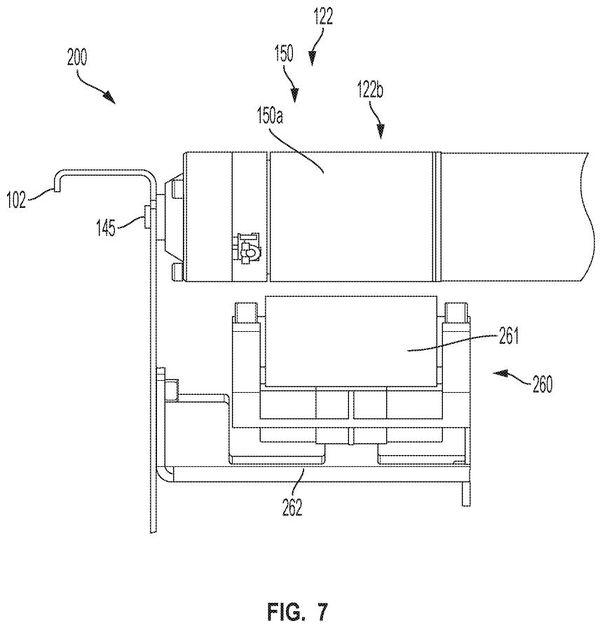

FIG. 7 illustrates an alternate embodiment of a conveying system 200, in accordance with one or more embodiments of the disclosure. The conveying roller system 200 includes a drive roller 122, which may be similar or identical to the previous drive roller 122 illustrated in FIGS. 2-6, a pressure support 260 to support the drive belt (not shown-see belt 116 described above), a bracket 262 for mounting the pressure support 260 to the side channel 102 by suitable method of attachments. As can be seen the drive roller 122 is also mounted to the side channel 102 via the hex axle 145. In this embodiment, the pressure support 260 is mounted beneath the conveying surface 112 such as the outer housing 150a of the clutch 150, the drive rollers 122, or the idle rollers 126 to increase the pressure of the drive belt against the outer housing 150a. Pressure support 260 includes a roller 261 to support the belt 116 against the outer housing 150a of the clutch 150 This arrangement may also be used in reference to conveyor system 400 described below.

FIG. 8 illustrates an example controller system in electronic communication with various other components of airless accumulation conveying system 100, in accordance with one or more embodiments of the disclosure. The airless accumulation conveying system 100 may be communicatively connected to one or more networks 300 via a control system 110. The control system 110 may include one or more controllers 110a, such as zone controllers, as noted above, and further, which may be mounted on-board the airless accumulation conveying system 100. In alternate embodiment, the controller system is a remote controller system. The network 300 is an Industrial Internet of Thing (IIOT) that connects the controller system with additional electronic components of the airless accumulation conveying system 100. Such additional electronic components may include one or more additional controllers that may send commands to the controller system indicating when it should divert articles toward a different load transfer point (not shown) other than the load transfer point. Alternatively, the format of information and/or commands received over the network 300 by the controller system may varies. In one embodiment, each controller 110a is connected to at least one clutch 150 and at least one sensor such as a photoeye 301.

Regardless of the specific format of the information transmitted over the network 300, the control system carries out the control of drive rollers 122 in such a manner as to deliver the articles to the appropriate load transfer point. The network 300 may include control area network (CAN), industrial Ethernet/Internet, EtherCAT, PROFINET, ProfiBUS, FieldBus, and other suitable fieldbus or local network technologies. In some implementation, the control system is communicatively connected to other industrial networking, in particular in accordance with IEEE 802,1xx Time-sensitive Network (TSN) that allows convergence of the plurality of proprietary fieldbus technologies existing today to a global standard. In other implementation, the network 300 may be integrated with cellular communications network such as 5G, 6G, or any next generation time domain synchronization technologies for enhancing performance in the industrial internet-of-thing (IIOT) environment. The control system allows zones to be independently operated as needed, such as to allow or have goods accumulate at one or more zones, as well as can operate all zones simultaneously together.

Referring to FIGS. 9 and 10, the numeral 400 generally designates another embodiment of an airless accumulation conveying system. Airless accumulation conveying system 400 is similar to airless accumulation conveying system 100 described above and includes a plurality of conveyor rollers 406 supported between opposed side channels 402, 404. As noted above, conveyor rollers 406 of conveying system 400 include idle rollers 426 that form the conveying surface 412 and a plurality of drive rollers 422 that are located beneath the conveying surface 412 and which selectively drive the idle rollers 426. Accumulation conveying system 400 further includes a continuous belt 416 that is formed by a drive belt 418, which is also located below conveying surface 412 and driven by a drive system, similar to drive system 120. Drive belt 418 drives the drive rollers 422 as described below. For other details not shown or specifically mentioned herein, reference is made to airless accumulation conveying system 100.

Similar to conveying system 100, as best seen in FIG. 9, conveying system 400 also includes a plurality of transmission belts in the form of O-rings 448 that are wound around the ends of the respective idle rollers 426 to transmit torque between the idle rollers, as well as to transmit torque from the drive rollers 422 via clutches when they are activated to be in their drive mode. For details of the drive rollers 422 and their construction and operation, reference is made to drive rollers 122.

In the illustrated embodiment, as noted, drive rollers 422 are located below idle rollers 426 and, hence, below conveying surface 412. Additionally, as best seen in FIG. 10, drive rollers 422 are located below the lower loop of the drive belt 418. To urge the lower loop of belt 418 into driving engagement with outer housing 550a of clutch 550, conveying system 400 includes a pressure support 460, similar to pressure support 260, which is mounted to side channel 402 by a bracket 462 but located above rollers 422 to urge belt 418 downward into engagement with outer housing 550a of clutch 550 of each respective drive roller 422. Similar to the above belt 118, belt 418 is in continuous motion and drives each outer housing 550a of clutches 550 as dictated by the control system. Only when the internal stationary coil of the clutch is energized, does the respective clutch 550 then engage and transmit torque from outer housing 550a to the cylindrical housing 428 of roller 422 to switch the drive roller between its idle mode and its drive mode. As noted above, the idle rollers are then driven by drive rollers 422 via O-rings 448. The energizing and hence actuation of clutches 550 of rollers 422 is controlled by the control system described above.

As previously described, a control system described with reference to the embodiments described herein may generally comprise one or more controllers with a processor, an input device coupled to the processor, an output device coupled to the processor, and memory devices each coupled to the processor. The processor may perform computations and control the modes and functions of the system, including executing instructions included in computer code for the tools and programs capable of implementing methods for monitoring warehouses, distribution centers, and intralogistics, in accordance with some embodiments, wherein the instructions of the computer code may be executed by the processor via a memory device. The computer code may include software or program instructions that may implement one or more algorithms for implementing one or more of the foregoing methods. The processor executes the computer code.

The memory device may include input data. The input data includes any inputs required by the computer code. The output device displays output from the computer code. A memory device may be used as a computer usable storage medium (or program storage device) having a computer-readable program embodied therein and/or having other data stored therein, wherein the computer-readable program comprises the computer code. Generally, a computer program product (or, alternatively, an article of manufacture) of the computer system may comprise said computer usable storage medium (or said program storage device).

As will be appreciated by one skilled in the art, the control system may include a computer program. Any of the components of the embodiments of the disclosure can be deployed, managed, serviced, etc. by a service provider that offers to deploy or integrate computing infrastructure with respect to embodiments of the inventive concepts. Thus, an embodiment of the disclosure discloses a process for supporting computer infrastructure, where the process includes providing at least one support service for at least one of integrating, hosting, maintaining and deploying computer-readable code (e.g., program code) in a computer system including one or more processor(s), wherein the processor(s) carry out instructions contained in the computer code causing the computer system for generating a technique described with respect to embodiments. In another embodiment, the disclosure discloses a process for supporting computer infrastructure, where the process includes integrating computer-readable program code into a computer system including a processor.

Aspects of the disclosures are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general purpose computer, special purpose computer, or other programmable data processing apparatus to produce a machine, such that the instructions, which execute via the processor of the computer or other programmable data processing apparatus, create means for implementing the modes/functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the mode/function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer-implemented process, such that the instructions which execute on the computer, other programmable apparatus, or other device implement the modes/functions/acts specified in the flowchart and/or block diagram block or blocks.

The flowchart and block diagrams in the Figures illustrate the architecture, functionality, and operation of possible implementations of systems, methods, and computer program products according to various embodiments of the disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified mode or functions or acts or carry out combinations of special purpose hardware and computer instructions.

It will be appreciated that numerous various to the above-mentioned approaches are possible. Variations to the above approaches may, for example, include performing the above steps in a different order.

While certain exemplary embodiments have been described and shown in the accompanying drawings, it is to be understood that such embodiments are merely illustrative of are not restrictive on the broad disclosure, and that this disclosure is not limited to the specific constructions and arrangements shown and described, since various other modifications may occur to those of ordinary skill in the art. The description is thus to be regarded as illustrative instead of limited.

1. An airless accumulation conveying system, said airless accumulation conveying system comprising:
a plurality of conveyor rollers, a group of said plurality of conveyor rollers defining a conveying surface;
a plurality of sensors for detecting and/or identifying articles transported on the conveying surface; and
wherein said plurality of rollers includes one or more of drive rollers, support rollers, and idle rollers.

2. The airless accumulation conveying system of claim 1, further comprising a continuous belt, and wherein said continuous belt selectively drives at least a portion of said conveying surface.

3. The airless accumulation conveying system of claim 1, wherein the sensors comprise one or more of pairs of photoeyes and reflectors, optical sensors, infrared (IR) sensors, object sensors, cameras, imaging sensors, Lidar sensors, radar sensors, sonar sensors, or other suitable sensing device, micromechanical system (MEMS) sensors, nano sensors, electrodes.

4. The airless accumulation conveying system of claim 1, comprising a pair of side channels between which said plurality of conveyer rollers are disposed.

5. The airless accumulation conveying system of claim 4, wherein said sensors are mounted to said side channels.

6. The airless accumulation conveying system of claim 1, wherein said plurality of conveyor rollers includes a plurality of drive rollers and a plurality of idle rollers each drivingly coupled to another roller through a plurality of transmission belts.

7. The airless accumulation conveying system of claim 1, wherein each drive roller includes a housing, a first bearing assembly at one end of said housing, a second bearing at an opposed end of said housing, and a wrapped-spring clutch between said housing and said second bearing assembly, wherein when said wrapped-spring clutch is energized, said wrapped-spring clutch transmits torque to drive rotation of said drive roller housing, and wherein when said wrapped-spring clutch is not energized, said drive roller housing is freely rotatable with respect to said first and second bearing assemblies and said wrapped-spring clutch.

8. The airless accumulation conveying system of claim 4, further comprising a pressure support, a bracket for mounting the pressure support to said side channel, and wherein said drive roller is also mounted to said side channel above or below said pressure support.

9. The airless accumulation conveying system of claim 1, further comprising a control system in electronic communication with various other components of the airless accumulation conveying system wherein the control system carries out the control of drive rollers in such a manner as to deliver articles to an appropriate load transfer point.

10. An airless accumulation conveying system, said airless accumulation conveying system comprising:
a plurality of conveyor rollers, said plurality of rollers including a drive roller and a group of idle rollers, at least said group idle rollers forming a conveying surface and being drivingly coupled together;
said drive roller being drivingly coupled to an idle roller, and said drive roller being configured to be selectively switched between an idle mode and a drive mode to selectively drive said idle rollers,
a continuous drive belt supported below said group of idle rollers and being configured to transmit torque to said drive roller so that when said drive roller is in said drive mode, said drive roller is operable to drive said idle rollers.

11. The airless accumulation conveying system of claim 10, wherein said drive roller includes a housing and a wrap spring clutch, when said wrap spring clutch is energized, said wrap spring clutch transmits torque to allow said drive belt to drive rotation of said drive roller housing, and when said wrapped-spring clutch is not energized, said drive roller housing is drivingly disengaged from said drive belt and is freely rotatable and operates in an idle mode.

12. The airless accumulation conveying system of claim 11, wherein a first end of a drive roller includes a first bearing assembly at one end of said housing and a second bearing at an opposed end of said housing, and a wrapped-spring clutch between said housing and said second bearing assembly.

13. The airless accumulation conveying system of claim 10, wherein said drive roller forms a part of said conveying surface.

14. The airless accumulation conveying system of claim 10, wherein said drive roller is located below said idler rollers and forms not part of the conveying surface.

15. A drive roller comprising:
a cylindrical housing having a longitudinal axis of rotation;
a first bearing assembly at a first end of said cylindrical housing for mounting one end of said drive roller in a conveyor section of a conveying system;
a second bearing at an opposed end of said cylindrical housing for mounting a second, opposed end of said drive roller in a conveyor section of a conveying system; and
an electro mechanical clutch between said housing and said second bearing assembly, wherein when said clutch is energized, said clutch is operable to transmit torque to drive rotation of said drive roller housing about said longitudinal axis of rotation, and wherein when clutch is not energized, said drive roller housing is freely rotatable with respect to said first and second bearing assemblies and said clutch.

16. The drive roller according to claim 15, wherein said clutch comprises a wrapped-spring clutch.

17. The drive roller according to claim 16, wherein said wrapped-spring clutch includes an outer housing forming an engagement surface for engagement by a drive belt.

18. The drive roller according to claim 17, wherein said wrapped-spring clutch further includes an insert extending from said outer housing to form a press fit coupling with said cylindrical housing of said drive roller.
